(19) United States
(12) Patent Application Publication
(10) Pub. No.: US 2023/0415715 A1
(43) Pub. Date: Dec. 28, 2023

(54) METHODS AND APPARATUS TO REDUCE END OF STOP JERK

(71) Applicant: Ford Global Technologies, LLC, Dearborn, MI (US)

(72) Inventors: Alexandra Sharlow, Brownstown, MI (US); Dale Scott Crombez, Livonia, MI (US); Steven Remington, Riverview, MI (US)

(21) Appl. No.: 17/850,601

(22) Filed: Jun. 27, 2022

(51) Int. Cl. B60T 8/24; B60T 8/172

(52) U.S. Cl. CPC B60T 8/24; B60T 8/172; B60T 2210/20; B60T 2230/04

(57) ABSTRACT

Methods, apparatus, systems, and articles of manufacture to reduce end of stop jerk are disclosed. An example vehicle includes a user interface, a brake system, and a controller to execute instructions to detect a command to engage the brake system at a command brake pressure, estimate a time until the vehicle comes to a stop, and in response to determining that the time satisfies a time threshold, engage the brake system at a delivered brake pressure less than the command brake pressure.

### FIELD OF THE DISCLOSURE

This disclosure relates generally to vehicles and, more particularly, to reduce end of stop jerks.

### BACKGROUND

Many vehicles include a brake-by-wire system and/or electrically boosted hydraulic brakes. Unlike mechanically boosted hydraulic brakes, the electrically boosted brakes increase applied brake pressure via electric actuators. Some electric brake systems (EBS) are configured such that, when the driver activates the brakes (e.g., via a brake pedal, etc.), an electrical command is sent to the actuators of the brakes, thereby causing additional braking force to be applied to the wheels.

### SUMMARY

An example vehicle described herein includes a user interface, a brake system, and a controller to execute instructions to detect a command to engage the brake system at a command brake pressure, estimate a time until the vehicle comes to a stop, and in response to determining that the time satisfies a time threshold, engage the brake system at a delivered brake pressure less than the command brake pressure.

An example method described herein includes detecting a command to engage a brake of a vehicle at a command brake pressure, estimating a time until the vehicle comes to a stop, and in response to determining that the time satisfies a time threshold, engaging the brake at a delivered brake pressure less than the command brake pressure.

An example non-transitory computer readable medium comprising instructions, which when executed cause a processor to at least detect a command to engage a brake of a vehicle at a command brake pressure, estimate a time until the vehicle comes to a stop, and in response to determining that the time satisfies a time threshold, engage the brake at a delivered brake pressure less than the command brake pressure.

### BRIEF DESCRIPTION OF THE DRAWINGS

FIG. 1 is a perspective view of a vehicle in which examples disclosed herein can be implemented.

FIG. 2 is a system diagram of the brake system of FIG. 1.

FIG. 3 is a block diagram of the brake controller of FIGS. 1 and 2.

FIG. 4 is a graph that illustrates the function of the brake controller of FIGS. 1-3 in reducing brake jerk while the vehicle of FIG. 1 is braking to a stop.

FIGS. 5A-5D illustrate the vehicle of FIG. 1 on various grades.

FIG. 6 is a flowchart representative of example machine readable instructions and/or example operations that may be executed by example processor circuitry to implement the brake controller of FIG. 2.

FIG. 7 is a block diagram of an example processing platform including processor circuitry structured to execute the example machine readable instructions and/or the example operations of FIG. 3 to implement the brake controller of FIG. 2.

FIG. 8 is a block diagram of an example implementation of the processor circuitry of FIG. 3.

FIG. 9 is a block diagram of another example implementation of the processor circuitry of FIG. 3.

In general, the same reference numbers will be used throughout the drawing(s) and accompanying written description to refer to the same or like parts. The figures are not to scale.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

### DETAILED DESCRIPTION

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

As used herein, the orientation of features is described with reference to a lateral axis, a vertical axis, and a longitudinal axis of the vehicle associated with the features. As used herein, the longitudinal axis of the vehicle is parallel to a centerline of the vehicle. The terms “rear” and “front” are used to refer to directions along the longitudinal axis closer to the rear of the vehicle and the front of the vehicle, respectively. As used herein, the vertical axis of the vehicle is perpendicular to the ground on which the vehicle rests. The terms “below” and “above” are used to refer to directions along the vertical axis closer to the ground and away from the ground, respectively. As used herein, the lateral axis of the vehicle is perpendicular to the longitudinal and vertical axes and is generally parallel to the axles of the vehicle. As used herein, the terms “longitudinal,” and “axial” are used interchangeably to refer to directions parallel to the longitudinal axis. As used herein, the terms “lateral” and “horizontal” are used to refer to directions parallel to the lateral axis. As used herein, the term “vertical” is used interchangeably to refer to directions parallel to the vertical axis.

When a driver applies the brakes to bring a vehicle to a stop, the driver can experience inconsistent brake feedback and an unpleasant rock-back motion. As used herein, the sensation and vehicle motion experienced as the vehicle comes to a stop is referred to as “end of stop (EOS) jerk.” EOS jerk can be caused by suspension wind-up and the sudden grip of the brakes associated with the transition from dynamic friction to static friction. The magnitude of the EOS jerk can depend on different types of brake linings, suspension stiffness, brake pedal sensitivity, and driver skill. Many drivers have difficulty controlling EOS jerk, which can cause unpleasant driving experiences for them and other passengers in the vehicle.

Some vehicles include electric brake boosters (EBB) to assist users of the vehicles in applying the necessary brake force to sufficiently slow the vehicle. Like vacuum brake boosters, EBBs include gear unit(s) that convert torque from an electric motor into hydraulic pressure for the brake. EBBs can detect the actuation of the brake pedal via an integrated differential travel sensor and generate a power request for the electric motor. Additionally, brake-by-wire systems enable the displacement of the brake pedal to be used to directly control the deceleration rate of a vehicle. As used herein, the “command brake pressure” is the amount of brake pressure requested by an operator (e.g., a driver, an autonomous driving system, etc.) of the vehicle (e.g., via brake pedal, etc.) and “the delivered brake pressure” is the amount of brake pressure actually applied by the brake.

Example methods and apparatus disclosed herein reduce EOS jerk using EBB and/or brake-by-wire systems by automatically reducing the applied brake pressure immediately prior to a vehicle coming to a stop. Examples disclosed herein include estimating when a vehicle is going to stop based on the velocity of the vehicle and deceleration rate of the vehicle and automatically adjusting the applied brake pressure via an EBB or brake motor to reduce EOS jerk without affecting stopping distance. Examples disclosed herein including applying a gain value gradient to the command brake pressure that is proportional to the estimated amount of time until the vehicle stops. Examples disclosed herein include gradually returning the applied gain value to the commanded brake torque after the vehicle comes to a complete stop.

In some examples disclosed herein, the direction and magnitude of the grade on which the vehicle is disposed is calculated simultaneously to modulate the delivered brake pressure reduction related to reducing EOS jerk. In some examples disclosed herein, if the magnitude of the grade satisfies a first threshold, a gain value a grade based modification (e.g., a second gain) is applied to the command brake pressure to reduce the difference between the delivered brake pressure and the command brake pressure. In some examples disclosed herein, if the magnitude of the grade satisfies a second threshold greater than the first threshold, no gain is applied to the commanded brake pressure.

Prior methods of reducing EOS jerk, like those in disclosed in Murakami, U.S. Pat. No. 4,852,950, reduce EOS jerk based on the instantaneous speed of the vehicle. Such prior methods resulted in inconsistent braking behavior depending on how hard the vehicle was braking. Due to inaccuracy and poor resolution of vehicle speed sensors at low speeds, prior methods were unable to reduce brake torque immediately prior to the vehicle coming to a stop. Further, prior methods had noticeable effects on the feedback feel of the vehicle for the driver and increased stopping distance during low-speed stops. Examples disclosed herein avoid these deficiencies by reducing EOS jerk based on an estimated time until the vehicle is stopped, thereby enabling a reduction of brake pressure only immediately prior to the vehicle stopping.

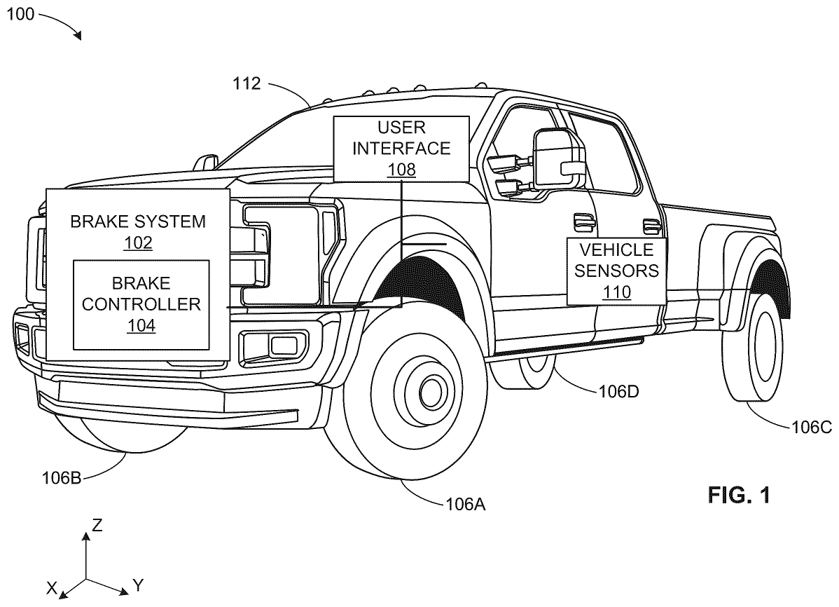

FIG. 1 is a perspective view of a vehicle 100 in which examples disclosed herein can be implemented. In the illustrated example of FIG. 1, the vehicle 100 includes an example brake system 102, an example brake controller 104, an example first wheel 106A, an example second wheel 106B, an example third wheel 106C, and an example fourth wheel 106D. In the illustrated example of FIG. 1, the vehicle 100 further includes an example user interface 108, example vehicle sensors 110, and an example cabin 112.

The vehicle 100 is a motorized wheel-driven vehicle. In the illustrated example of FIG. 1, the vehicle 100 is a pick-up truck. In other examples, the vehicle 100 can be any type of vehicle with brakes (e.g., a sedan, a coupe, a van, a pick-up truck, a sports utility vehicle, an all-terrain vehicle (ATV), farming equipment, etc.). In some examples, the vehicle 100 includes an internal combustion engine (e.g., a non-electrified vehicle, a partially electrified vehicle, etc.). In other examples, the vehicle 100 can be implemented as a fully electric vehicle. In some examples, the vehicle 100 can be a fully autonomous vehicle and/or a partially autonomous vehicle.

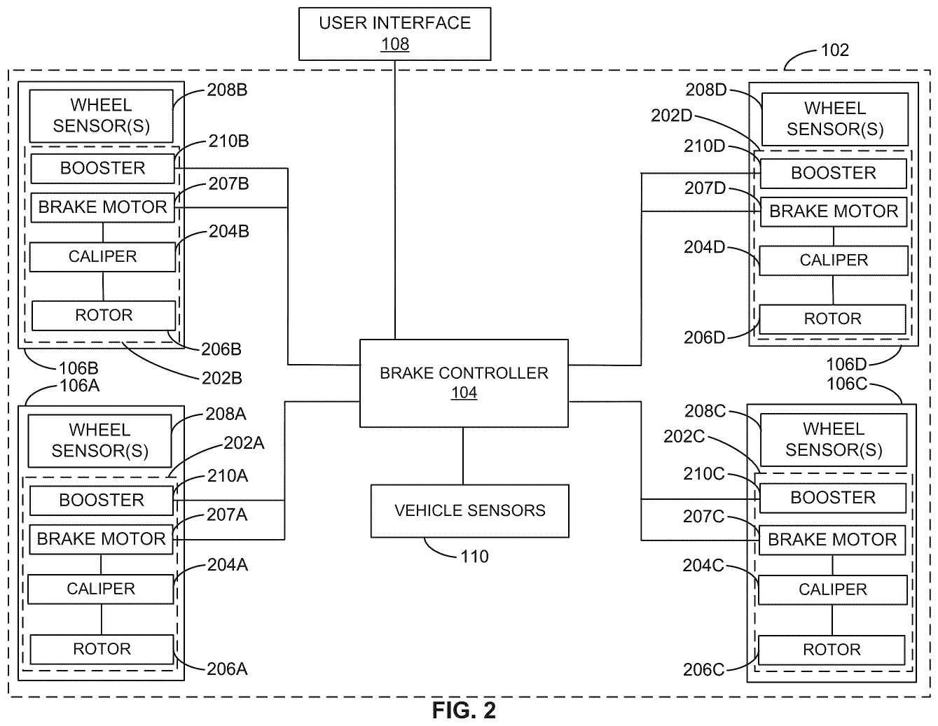

The brake system 102 includes mechanical and electrical components that retard the rotation of the wheels 106A, 106B, 106C, 106D. The brake system 102 can receive user input (e.g., via the user interface 108, etc.) and cause activation of one or more brake(s) of the brake system 102. While the brake system 102 is described herein as a friction disc brake system, the examples described herein can also be applied to any other suitable type of brake system (e.g., a drum brake system, a dual disc-drum brake system, a clasp brake system, band brake systems, electromagnetic brakes, etc.). In some examples, the brake system 102 can include regenerative braking components. The example brake system 102 can be a hydraulic brake system, an electro-magnetic system, and/or a hybrid system. In some examples, the brake system 102 can be a brake-by-wire system. In other examples, if the brake system 102 is not a brake-by-wire system, the brake pressure applied by the brake system 102 can be regulated by the brake controller 104 via one or more fluid valves. An example implementation of the brake system 102 is described in greater detail below in FIG. 2.

The wheels 106A, 106B, 106C, 106D include a wheel rim and a corresponding tire. While in the illustrated example of FIG. 1, the vehicle 100 has two axles and four wheels, in other examples, the vehicle 100 can have any number of axles and wheels. In the illustrated example of FIG. 1, the first wheel 106A and the second wheel 106B are front wheels and the third wheel 106C and the fourth wheel 106D are rear wheels. In the illustrated example of FIG. 1, the first wheel 106A and the third wheel 106C are driver-side wheels and the second wheel 106B and the fourth wheel 106D are passenger-side wheels.

The user interface 108 enables a user of the vehicle 100 to receive and input information to the brake system 102 and other systems of the vehicle 100. For example, the user interface 108 can include a display of the vehicle 100. In some examples, the user interface 108 can include an interface to operate the brake system 102 during operation of the vehicle 100 (e.g., a brake pedal, a hand lever, etc.). In some examples, the user interface 108 can receive instructions, warnings, and/or alerts from the brake controller 104 regarding the status of the brake system 102. Additionally or alternatively, the user interface 108 can include one or more dash indicator(s), one or more button(s) on the dashboard or steering wheel, one or more speakers, one or more microphones, etc. In some examples, the user interface 108 can be fully or partially implemented by a mobile device of the user (e.g., a mobile phone, a smartwatch, a tablet, etc.).

In the illustrated example of FIG. 1, the vehicle 100 includes the cabin 112. The cabin 112 is an enclosed portion (e.g. fully enclosed and/or partially enclosed, etc.) of the vehicle 100 where the driver and/or other passengers are seated during operation of the vehicle 100. Because the cabin 112 is part of the sprung mass of the vehicle 100, EOS jerk causes the cabin 112 and occupants thereof experience rock-back motion relative to the wheels 106A, 106B, 106C, 106D.

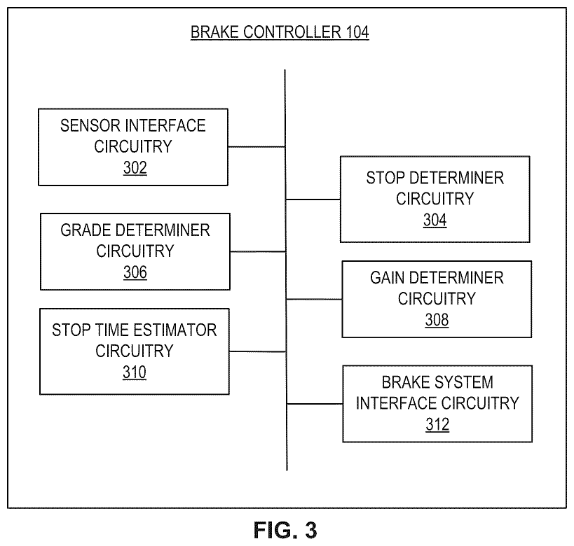

During the operation of the vehicle 100, the brake system 102 is controlled via the brake controller 104. For example, in response to a user input (e.g., the depression of a brake pedal, etc.) and/or an automated input (e.g., the vehicle 100 detecting an imminent obstacle in front of the vehicle 100, etc.), the brake controller 104 can cause the brake system 102 to retard the rotation of some or all of the wheels 106A, 106B, 106C, 106D, thereby slowing the vehicle 100. For example, the brake system 102 can receive a command brake pressure via a physical connection (e.g., hydraulic action, pneumatic action, one or more mechanical connections, etc.) with the user interface 108. Additionally or alternatively, if the brake system 102 is a brake-by-wire system, the brake system 102 can determine a command brake pressure based on an input from the user interface 108 (e.g., the brake system can correlate a magnitude of depression of a brake pedal with a corresponding command brake pressure, etc.). The brake controller 104 is described in greater detail below in FIGS. 2 and 3.

The vehicle sensors 110 measure the properties of the vehicle 100. For example, the vehicle sensors 110 can include accelerometers and speedometers. In some such examples, one or more accelerometers can be configured in a manner that permits the determination of a direct and magnitude of the grade of a driving surface on which the vehicle is disposed. In such examples, the vehicle sensors 110 can be a component of another vehicle system.

FIG. 2 is a system diagram of the brake system 102 of FIG. 1. In the illustrated example of FIG. 2, the brake system 102 includes the example brake controller 104 of FIG. 1. In the illustrated example of FIG. 2, the brake system 102 includes an example first brake 202A, an example second brake 202B, an example third brake 202C, and an example fourth brake 202D, which are associated with the first wheel 106A, the second wheel 106B, the third wheel 106C, and the fourth wheel 106D, respectively. In the illustrated example of FIG. 2, the first brake 202A includes an example first caliper 204A, an example first rotor 206A, and an example first brake motor 207A. In the illustrated example of FIG. 2, the second brake 202B includes an example second caliper 204B, an example second rotor 206B, and an example second brake motor 207B. In the illustrated example of FIG. 2, the third brake 202C includes an example third caliper 204C, an example third rotor 206C, and an example third brake motor 207C. In the illustrated example of FIG. 2, the fourth brake 202D includes an example fourth caliper 204D, an example fourth rotor 206D, and an example fourth brake motor 207D. In the illustrated example of FIG. 2, the brake system 102 includes example first wheel sensors 208A, example second wheel sensors 208B, example third wheel sensors 208C, example fourth wheel sensors 208D, which are associated with the wheels 106A, 106B, 106C, 106D, respectively. In the illustrated example of FIG. 2, the brakes 202A, 202B, 202C, 202D include an example first brake booster 210A, an example second brake booster 210B, an example third brake booster 210C, and an example fourth brake booster 210D.

The brake controller 104 controls the brakes 202A, 202B, 202C, 202D of the vehicle 100. For example, the brake controller 104 can cause the calipers 204A, 204B, 204C, 204D to engage the corresponding ones of the rotors 206A, 206B, 206C, 206D during the operation of the vehicle 100 (e.g., to bring the vehicle 100 from a velocity to a stop, to hold the vehicle, etc.). In some examples, the brake controller 104 communicates with the calipers 204A, 204B, 204C, 204D via a controller area network (CAN) bus of the vehicle 100. Additionally or alternatively, the brake controller 104 can communicate with the calipers 204A, 204B, 204C, 204D via an independent communication system (e.g., an electrical communication system, a hydraulic communication system, etc.). The brake controller 104 can be implemented by an electronic control unit of the vehicle 100 (e.g., a dedicated brake control module (BCM), one or more vehicle control module(s) (VCM), one or more domain controller(s), etc.). In other examples, some or all of the components of the brake controller 104 can be implemented by one or more other system(s) of the vehicle 100 (e.g., the anti-lock brake system (ABS), the electronic stability system (ESC), a powertrain controller, a transmission controller, etc.).

The calipers 204A, 204B, 204C, 204D are mechanical components that receive inputs from the brake controller 104. In some examples, if the brake system 102 is a brake-by-wire system, after receiving an input (e.g., a braking signal, etc.) from the brake controller 104, the brake motors 207A, 207B, 207C, 207D can cause the calipers 204A, 204B, 204C, 204D to apply a clamping pressure (e.g., via one or more pistons, etc.) to a respective one of the rotors 206A, 206B, 206C, 206D. Additionally or alternatively, if the brake system is a conventional hydraulic system and the brake motors 207A, 207B, 207C, 207D are absent, the force applied by a user of the vehicle 100 (e.g., via a brake pedal, etc.) is converted into hydraulic pressure used to press the calipers 204A, 204B, 204C, 204D into the rotors 206A, 206B, 206C, 206D. Regardless of the braking mechanism, the application of the calipers 204A, 204B, 204C, 204D, slows the rotation of the corresponding one of the wheels 106A, 106B, 106C, 106D. In some examples, the calipers 204A, 204B, 204C, 204D can include brake pads, which are designed to abrade on contact with the rotors 206A, 206B, 206C, 206D, thereby preventing damage, deformation, and/or warping to the rotors 206A, 206B, 206C, 206D and the calipers 204A, 204B, 204C, 204D.

The rotors 206A, 206B, 206C, 206D are discs that are connected to the wheels 106A, 106B, 106C, 106D, respectively. The rotors 206A, 206B, 206C, 206D are rigidly connected to and rotate with the wheels 106A, 106B, 106C, 106D. During operation of the brakes 202A, 202B, 202C, 202D, the calipers 204A, 204B, 204C, 204D apply a frictional force to the rotors 206A, 206B, 206C, 206D, thereby slowing the rotation of the corresponding one of the wheels 106A, 106B, 106C, 106D.

The wheel sensors 208A, 208B, 208C, 208D are associated with the respective ones of the wheels 106A, 106B, 106C, 106D to measure characteristics associated with the wheels 106A, 106B, 106C, 106D, and the brakes 202A, 202B, 202C, 202D. For example, the wheel sensors 208A, 208B, 208C, 208D can include sensors that measure the force and/or pressure applied by the calipers 204A, 204B, 204C, 204D. In some examples, the wheel sensors 208A, 208B, 208C, 208D include one or more thermometers that measure the individual rotational speeds of each of the wheels 106A, 106B, 106C, 106D. Additionally or alternatively, the wheel sensors 208A, 208B, 208C, 208D can include any other suitable sensors.

The boosters 210A, 210B, 210C, 210D are devices that increase the torque applied by the calipers 204A, 204B, 204C, 204D onto the rotors 206A, 206B, 206C, 206D. The boosters 210A, 210B, 210C, 210D enable the brake controller 104 to deliver delivered brake pressures different than command brake pressure received from the user interface 108. For example, the boosters 210A, 210B, 210C, 210D can increase the delivered brake pressure relative to the command brake pressure if the vehicle 100 needs to stop quickly. The brake controller 104 can detect an actuation of the brake pedal (e.g., via an integrated differential travel sensor of the vehicle sensors 110, etc.), which in turn generates a command signal to the boosters 210A, 210B, 210C, 210D to modify the applied brake torque. In the illustrated example of FIG. 2, the boosters 210A, 210B, 210C, 210D are electric brake boosters. In other examples, the boosters 210A, 210B, 210C, 210D can be any suitable type of brake boosters (e.g., vacuum boosters, hydraulic brake boosters, etc.) In some examples, the boosters 210A, 210B, 210C, 210D are absent (e.g., the system is an electro-magnetic brake-by-wire system, etc.).

After receiving the command brake pressure, the brake controller 104 can brake the wheels 106A, 106B, 106C, 106D by engaging the calipers 204A, 204B, 204C, 204D to corresponding ones of the rotors 206A, 206B, 206C, 206D at a delivered brake pressure. In some examples, during normal operation of the vehicle 100, the delivered brake pressure is equal to the commanded brake pressure. In some examples, when the vehicle 100 is braking to a stop, the brake controller 104 can estimate when the vehicle 100 is coming to a stop and apply a delivered brake pressure that is less than the commanded brake pressure immediately prior (e.g., within 1 second, etc.) to mitigate EOS jerk. In some such examples, the brake controller 104 can continue to apply a delivered brake pressure lower than the commanded brake pressure for a threshold time period and then apply a delivered brake pressure equal to the commanded brake pressure. An example implementation of the brake controller 104 is described below in conjunction with FIG. 3.

FIG. 3 is a block diagram of the brake controller 104 to control the brake system 102 of FIGS. 1-2. In the illustrated example of FIG. 2, the brake controller 104 includes example sensor interface circuitry 302, example stop determiner circuitry 304, example grade determiner circuitry 306, example gain determiner circuitry 308, example stop estimator circuitry 310, and example brake system interface circuitry 312. The brake controller 104 of FIG. 3 may be instantiated (e.g., creating an instance of, bring into being for any length of time, materialize, implement, etc.) by processor circuitry such as a central processing unit executing instructions. Additionally or alternatively, the brake controller 104 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

The sensor interface circuitry 302 accesses sensor data from the sensors 208A, 208B, 208C, 208D, 110 of the example vehicle 100 and/or brake system 102. In some examples, the sensor interface circuitry 304 can transform the received sensor data from a machine-readable format (e.g., a voltage, a current, etc.) to a human-readable format (e.g., a string, a floating-point number, an integer, etc.).

The stop determiner circuitry 304 determines if the vehicle 100 is undergoing a stop. For example, the stop determiner circuitry 304 can determine if the vehicle 100 is undergoing a stop based on a detection of the engagement of the brake system 102. In some examples, the stop determiner circuitry 304 can differentiate between vehicle slowing (e.g., to maintain distance in traffic, during yielding, etc.) and vehicle stopping (e.g., to avoid obstacles, to stop at a traffic control feature, etc.) based on a level of engagement of the brake system 102. For example, the stop determiner circuitry 304 can compare the command brake pressure to a threshold command brake pressure. In other examples, the stop determiner circuitry 304 can determine if the vehicle 100 is coming to stop by any other suitable means (e.g., via vehicle cameras, a user input, etc.).

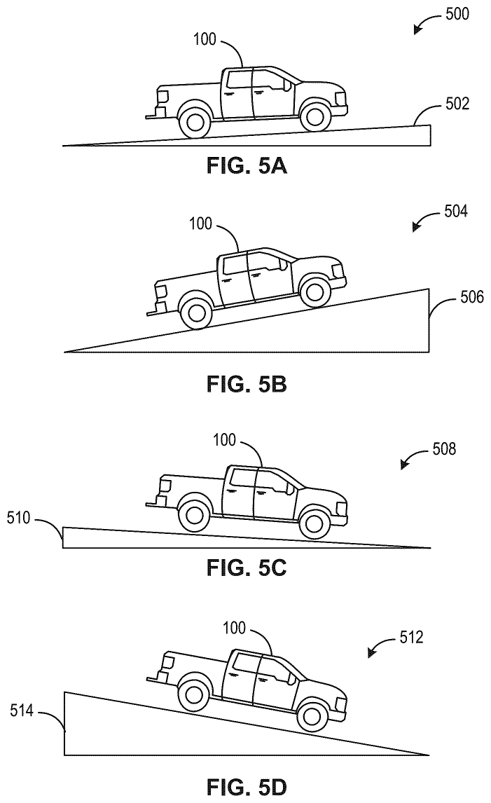

The grade determiner circuitry 306 determines the direction and magnitude of the grade of the driving surface on which the vehicle 100 is disposed. For example, the grade determiner circuitry 306 determines the magnitude of the grade the vehicle is on via sensor data from the vehicle sensors 110 (e.g., an accelerometer, an optical sensor, etc.). Additionally or alternatively, the grade determiner circuitry 306 can determine the direction and magnitude of grade based on a user input from the user interface 108. In some examples, the grade determiner circuitry 306 can compare the determined grade to one or more threshold grades to determine if the delivered brake pressure needs to be modified based on the determined grade. In some examples, the threshold grades can be set by a user of the vehicle 100 and/or a manufacturer of the vehicle 100. In other examples, grade determiner circuitry 306 can determine the threshold grade(s) based on a load of the vehicle 100, the environmental conditions (e.g., the weather conditions, the external temperature, etc.), the make/model of the vehicle 100, and/or any other suitable metric. The function of the grade determiner circuitry 306 is described below in additional detail in conjunction with FIGS. 5A-5D.

The gain determiner circuitry 308 determines the amount of gain to apply to the commanded brake pressure to generate the brake torque to be applied as the vehicle 100 is coming to a stop. In some examples, the gain determiner circuitry 308 can determine the gain to apply to the command brake pressure based on a manufacturer setting and/or a user setting. In some such examples, the manufacturer setting and/or user setting can be based on a make and/or a model of the vehicle 100. Additionally or alternatively, the gain determiner circuitry 308 can determine the gain to apply to the command brake pressure based on sensor data received from the wheel sensors 208A, 208B, 208C, 208D and/or the vehicle sensors 110 (e.g., a load on the vehicle, a brake fade of the brakes 202A, 202B, 202C, 202D, an environmental condition, etc.). In some examples, the gain determiner circuitry 308 can determine a modification to the determined gain based on the direction and/or magnitude of grade determined by the grade determiner circuitry 306. In some examples, if the magnitude of the grade is between a first threshold (e.g., a 3% grade, etc.) and a second threshold (e.g., a 10% grade, etc.), the gain determiner circuitry 308 can determine a second gain to apply to the command brake pressure. In some such examples, the delivered brake pressure can monotonically increase (e.g., linearly, via curve, etc.) from a minimum delivered brake pressure, when the magnitude of the grade is equal to the first threshold, to the command brake pressure, when the grade is equal to the second threshold. In other examples, the delivered brake pressure can scale to a pressure less or equal to command brake pressure (e.g., 99% of the command brake pressure, 95% of the command brake pressure. 75% of the command brake pressure, etc.). In some examples, if the magnitude of the grade satisfies the second threshold, the gain determiner circuitry 308 does not apply a gain or applies a gain of 1 to the command brake pressure such that the command brake pressure is equal to the delivered brake pressure.

The stop time estimator circuitry 310 estimates the amount of time until the vehicle 100 comes to a stop. As used herein, the phrase “comes to a stop” refers to the time when the wheels 106A, 106B, 106C, 106D stop rotating (e.g., the friction experienced by the wheels changes from dynamic resistance/rolling resistance to static friction, etc.). After the vehicle 100 comes to a stop, the sprung mass of the vehicle 100 (e.g., including the cabin 112 of FIG. 1, etc.) continues to move relative to the wheels 106A, 106B, 106C, 106D. In some such examples, the sprung mass of the vehicle 100 continues to move relative to the wheels 106A, 106B, 106C, 106D which can be experienced as EOS jerk. The stop time estimator circuitry 310 can estimate the time until the vehicle comes to a stop based on the current velocity of the vehicle 100 (e.g., determined via the wheel sensors 208A, 208B, 208C, 208D, etc.), a deceleration rate of the vehicle 100, and properties of the wheel sensors 208A, 208B, 208C, 208D. In some examples, the stop time estimator circuitry 310 can use kinematic principles to determine the time until the vehicle 100 comes to a stop (e.g., the ratio of current velocity to the acceleration, etc.). In some examples, the stop time estimator circuitry 310 can estimate the time until stop based on historic driver data (e.g., via a look-up table, via machine-learning algorithm, etc.).

In some examples, the wheel sensors 208A, 208B, 208C, 208D can have relatively low resolutions at low rotational speeds. For example, if the wheel speeds sensors 208A, 208B, 208C, 208D are mechanical rotary sensors, optical rotary sensors, and/or magnetic rotary sensors, the wheel speed sensors 208A, 208B, 208C, 208D function by measuring the rate at which notable features (e.g., gear teeth, optical elements, etc.) coupled to corresponding the wheels 106A, 106B, 106C, 106D rotate past and interact with, the sensing elements of the wheel speed sensors 208A, 208B, 208C, 208D. In some such examples, at very low speeds like those immediately prior to the vehicle 100 coming to a stop, the notable features do not interact with the wheel speed sensors 208A, 208B, 208C, 208D in a manner that permits the determination of the speed of the vehicle 100. That is, in some examples, at very low speeds, the wheel speed sensors 208A, 208B, 208C, 208D can output a velocity of zero even when the wheels 106A, 106B, 106C, 106D are still slowly rotating. In some such examples, the stop time estimator circuitry 310 can account for the lack of resolution of the wheel speed sensors 208A, 208B, 208C, 208D at low speeds (e.g., by applying a multiplicative factor, by adding a fixed amount, applying a filter, etc.).

The brake system interface circuitry 312 interfaces with the brake system 102. For example, the brake system interface circuitry 312 can interface with the brake motors 207A, 207B, 207C, 207D and/or the boosters 210A, 210B, 210C, 210D to deliver the delivered brake pressure to the wheels 106A, 106B, 106C, 106D. In some examples, the brake system interface circuitry 312 can transition between different applied brake pressures gradually (e.g., linearly, as a ramp function, as a series of step functions, etc.). In other examples, the brake system interface circuitry 312 can interface with the brake system 102 by any other suitable means.

While an example manner of implementing the brake controller 104 of FIGS. 1 and 2 is illustrated in FIG. 3, one or more of the elements, processes, and/or devices illustrated in FIG. 3 may be combined, divided, re-arranged, omitted, eliminated, and/or implemented in any other way. Further, the example sensor interface circuitry 302, the stop determiner circuitry 304, the example grade determiner circuitry 306, the example gain determiner circuitry 308, the stop time estimator circuitry 310, the brake system interface circuitry 312, and/or, more generally, the example brake controller 104 of FIGS. 1 and 2, may be implemented by hardware alone or by hardware in combination with software and/or firmware. Thus, for example, any of the example sensor interface circuitry 302, the stop determiner circuitry 304, the example grade determiner circuitry 306, the example gain determiner circuitry 308, the stop time estimator circuitry 310, the brake system interface circuitry 312, and/or, more generally, the example brake controller 104 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example brake controller 104 of FIGS. 1 and 2 may include one or more elements, processes, and/or devices in addition to, or instead of, those illustrated in FIG. 3, and/or may include more than one of any or all of the illustrated elements, processes and devices.

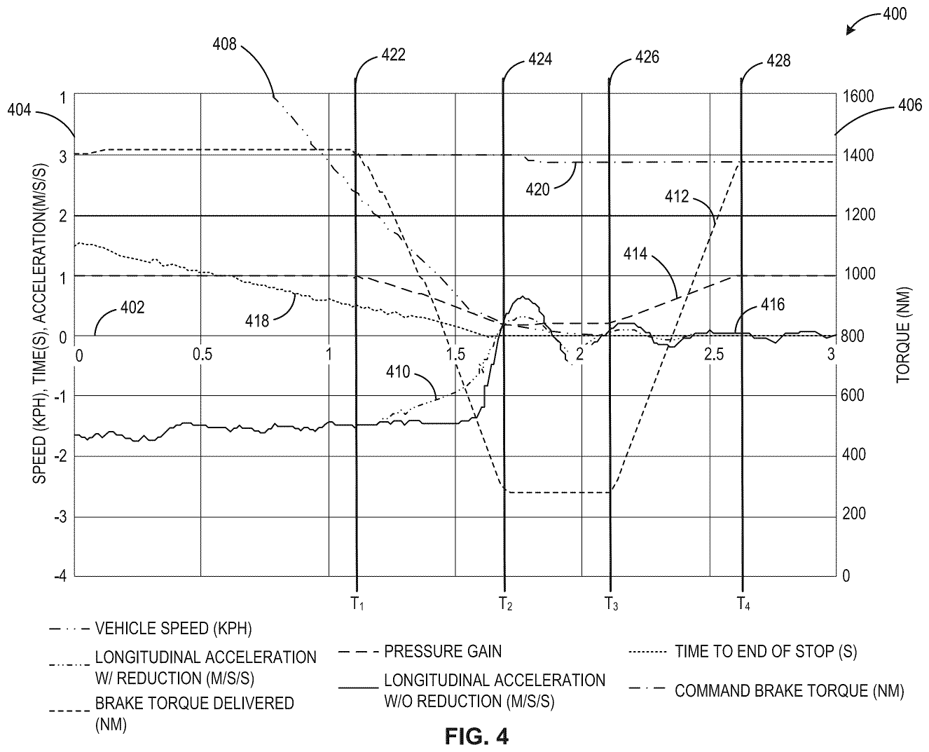

FIG. 4 is an example graph 400 that illustrates the function of the brake controller 104 of FIGS. 1-3 in reducing brake jerk while the vehicle 100 of FIG. 1 is braking to a stop. In the illustrated example of FIG. 4, the graph 400 includes an example x-axis 402, an example first y-axis 404, and an example second y-axis 406. In the illustrated example of FIG. 4, the graph 400 includes an example first line 408, corresponding to vehicle speed, an example second line 410, corresponding to vehicle acceleration, an example third line 412, corresponding to delivered brake torque, an example fourth line 414, corresponding to gain applied to the command brake torque, an example fifth line 416, corresponding to would-be vehicle acceleration with the command torque, an example sixth line 418, corresponding to the estimated time until stop, and an example seventh line 420, corresponding to the command brake torque. In the illustrated example of FIG. 4, the values associated with the axes 402, 404, 406 are for illustrative purposes only and, in other examples, the values associated with each of the lines 408, 410, 412, 414, 416, 418, 420 can have any suitable values.

The x-axis 402 measures the independent variable time, which begins at 0 seconds, and ends at 3 seconds. While measured in seconds in the illustrated example of FIG. 4, in other examples, the x-axis can be measured in any suitable unit (e.g., seconds, minutes, etc.). The first y-axis 404 measures the values associated with the first line 408 (in kilometers per hour (KPH), the second line 410 (in meters per second squared (m/s/s)), the fourth line 414 (unitless), the fifth line 416 (in m/s/s), and the sixth line 418 (in seconds (s)). In the illustrated example of FIG. 4, the first y-axis 404 ranges in values for −4 to 4. In other examples, the first y-axis 404 can have any suitable range to ensure that the lines 408, 410, 414, 418 are visible.

The second y-axis 406 measures the values associated with the third line 412 (Newton-meters (Nm)) and the seventh line 420 (Nm). In the illustrated example of FIG. 4, the first y-axis ranges in values for 0 to 1600. In other examples, the second y-axis 406 can have any suitable range to ensure that the lines 412, 420 are visible. In the illustrated example of FIG. 4, the lines 412, 420 generally refer to an amount of torque applied to the rotors 206A, 206B, 206C, 206D of FIG. 2 by the calipers 204A, 204B, 204C, 204D of FIG. 2. In other examples, the lines 412, 420 can alternatively reflect the pressure applied to the calipers 204A, 204B, 204C, 204D of FIG. 2. In some examples, brake pressure and brake torque are directly proportional and may be used interchangeable.

In the illustrated example of FIG. 4, the vehicle 100 has begun braking prior to seconds (e.g., −2 seconds prior the beginning of diagram 400, etc.). In the illustrated example of FIG. 4, throughout the period of time depicted on the graph 400, the commanded brake torque, the seventh line 420, remains substantially constant. In some such examples, the value of the seventh line 420 generally corresponds to the magnitude of the user input (e.g., input via the depression of the brake pedal, etc.). In the illustrated example of FIG. 4, at example first time 422 (illustrated as T₁ in FIG. 4), the delivered brake torque, the third line 412, diverges from the command brake torque, the seventh line 420, due to the application of a pressure gain, the fourth line 414. The value of the fourth line 414 prior to the first time 422 is equal to 1, causing the command brake torque to be equal to the delivered brake torque. After the first time 422, a pressure gain of less than 1 is applied, thereby reducing the relative value of the delivered brake torque relative to the command brake torque. The temporal location of the first time 422 is based on the estimated time to the end of stop, the sixth line 418. That is, when the value of the sixth line 418 satisfies a time threshold (e.g., 500 milliseconds (ms) in FIG. 4, 350 ms, etc.), a pressure gain is applied to the command brake torque, thereby causing the divergence of the third line 412 and the seventh line 420. In some examples, the time threshold can between 100 ms and 15000 ms. In other examples, the time threshold can have any suitable threshold (e.g., as set by a user of the vehicle 100, a manufacturer of the vehicle 100, etc.).

In the illustrated example of FIG. 4, an example second time 424 (illustrated as T₂ in FIG. 4) is based on when the estimated time to the end of stop, the sixth line 418 is equal to zero. In the illustrated example of FIG. 4, the first line 408, the vehicle speed, is not illustrated as 0 at T₂. In some examples, the value of the first line 408 is based on sensor data (e.g., data from the sensors 110, 208A, 208B, 208C, 208D, etc.). As discussed above, the resolution of the sensors 110, 208A, 208B, 208C, 208D can result in poor accuracy at low speeds (e.g., −0.7 kph in FIG. 4, etc.). In some such examples, the value of the sixth line 418 being zero can be a better approximation of when the vehicle has come to a stop than the value of the first line 408. At the second time 424, the value of the third line 412 is at a minimum value compared to the seventh line 420, due to the comparatively low value of the pressure gain, the fourth line 414, being applied at the second time 424. In the illustrated example of FIG. 4, the fourth line 414, the gain, and thereby the third line 412, are ramped linearly down (e.g., via a ramp function, etc.) between the first time 422 and the second time 424. In other examples, the third line 412 and the fourth line 414 can be decreased by any other suitable relationship (e.g., via one or more step function(s), via a curve, etc.).

In the illustrated example of FIG. 4, an example third time 426 (illustrated as T₃ in FIG. 4) occurs at a threshold period (e.g., a fixed time, etc.) after the second time 424. In some examples, the threshold period is buffer to account for potential inaccuracy of the estimated time to the end. In the illustrated example of FIG. 4, the time between the second time 424 and the third time 426 is 500 ms. In other examples, the time between the second time 424 and the third time 426 can be any other suitable period (e.g., based on a manufacturer setting, based on a user setting, based on environmental conditions, based on a load on the vehicle 100, etc.). In some such examples, the threshold period can be omitted. Between the second time 424 and the third time 426, the third line 412 and the fourth line 414 are maintained at minimum values.

In the illustrated example of FIG. 4, an example fourth time 428 (illustrated as T₃ in FIG. 4), occurs after the delivered brake torque, the third line 412 has reconverged with the command brake torque, the seventh line 420. At the fourth time 428, the pressure gain, the fourth line 414, is equal to one. In the illustrated example of FIG. 4, the fourth line 414, the gain, and thereby the third line 412, are ramped linearly up between the third time 426 and the fourth time 428. In other examples, values of the third line 412 and the fourth line 414 can be increased by any other suitable relationship (e.g., via a step function, via a curve, etc.). Between the second time 424 and the fourth time 428, the magnitude of the oscillation of the second line 410 is lower than the magnitude of the oscillation of the fifth line 416. In the illustrated example of FIG. 4, the second line 410 also has a comparatively lower rate of change than the fifth line 416 (e.g., kinematic jerk, etc.). This oscillation in acceleration of the vehicle 100 and the kinematic jerk can be experienced by a driver of the vehicle 100 as EOS jerk. As such, by applying the pressure gain, the fourth line 414, and delivering a lower brake torque, the third line 412, than the command brake torque, the seventh line 420, the user of the vehicle 100 experiences reduced EOS jerk when compared to braking without the application of the pressure gain.

FIGS. 5A-5D illustrate the vehicle 100 of FIG. 1 on driving surfaces with different grades. In the illustrated example of FIG. 5A, the vehicle 100 is in an example first condition 500 on an example first grade 502. In the illustrated example of FIG. 5B, the vehicle 100 is in an example second condition 504 on an example second grade 506. In the illustrated example of FIG. 5C, the vehicle 100 is in an example third condition 508 on an example third grade 510. In the illustrated example of FIG. 5D, the vehicle 100 is in an example fourth condition 512 on an example fourth grade 514.

In the illustrated examples of FIGS. 5A and 5B, in the first condition 500 and the second condition 504 the vehicle 100 has stopped while traveling up on a driving surface with the first grade 502 and the second grade 506, respectively. In some examples, after stopping, the vehicle 100 may begin to roll back down the first grade 502 and the second grade 506 if the braking pressure applied to the brakes of the vehicle 100 does not compensate for the gravitation force associated with the first grade 502 and the second grade 506, respectively. In the illustrated examples of FIGS. 5C and 5D, in the third condition 508 and the fourth condition 512, the vehicle 100 has stopped while traveling down on a driving surface with the third grade 510 and the fourth grade 514, respectively. In some examples, after stopping, the vehicle 100 may begin to roll forward down the third grade 510 and/or the fourth grade 514 if the braking pressure applied to the brakes of the vehicle 100 does not compensate for the gravitational force associated with the third grade 510 and the fourth grade 514. Additionally, the gravitational force applied to the sprung mass of the vehicle 100 reduces the magnitude of EOS jerk associated with stops on the hill. In some such examples, the gain determiner circuitry 308 can reduce the gain applied to the command brake pressure as less brake pressure reduction is required to mitigate EOS jerk.

In the illustrated example of FIGS. 5A and 5C, the magnitudes of the grades 502, 510 are 3% (e.g., an upward grade and a downward grade, respectively). In such examples, the magnitudes of the grades 502, 510 correspond to the first threshold associated with the activation of the reduction of the gain applied to the command brake pressure. That is, for grades having magnitudes less than the magnitudes of the grades 502, 510, the gain applied to the first command pressure to reduce EOS jerk by the brake controller 104 is not modified based on the grade of the driving surface on which the vehicle 100 is disposed and for grades with magnitudes greater than magnitudes of the grades 502, 510, the gain applied to the first command pressure to reduce EOS jerk by the brake controller 104 is modified based on the grade of the driving surface. In other examples, the grades 502, 510 and the corresponding first threshold can have any other suitable threshold (e.g., 2% grade, 4% grade, etc.).

In the illustrated example of FIGS. 5B and 5D, the magnitudes of the grades 506, 514 are 10% (e.g., an upward grade and a downward grade, respectively). In such examples, the magnitudes of the grades 506, 514 correspond to the second threshold associated with the activation of the deactivation of the gain applied to the command brake pressure. That is, for grades with magnitudes less than the magnitudes of the grades 506, 514, the gain applied to the first command pressure to reduce EOS jerk by the brake controller 104 is modified based on the grade of the driving surface on which the vehicle 100 is disposed and for grades with magnitudes greater than the grades 506, 514, no gain is applied to the command pressure (e.g., a gain of 1 is applied, etc.). In other examples, when the second threshold is satisfied, the gain applied to the first command is set to a maximum value (e.g., 0.95, 0.75 etc.). In some such examples, when the second threshold is satisfied, the delivered brake pressure is equal to the command brake pressure (e.g., no gain is applied, a gain of 1 is applied) or less than the command brake pressure (e.g., a gain of 0.99 is applied, a gain of 0.8 is applied, etc.). In some examples, the magnitudes of the grades 506, 514 and the corresponding second threshold can have any other suitable threshold (e.g., 8% grade, 12% grade, etc.).

In the examples discussed herein, the first grade threshold and the second grade threshold are the same regardless of whether the vehicle 100 is ascending a grade or descending a grade. In other examples, the first threshold and the second threshold can vary based on the direction of travel of the vehicle 100. For example, the first threshold can be 3% when the vehicle 100 is traveling up a grade and 2.5% when the vehicle 100 is traveling down a grade. Additionally or alternatively, the second threshold can be 10% when the vehicle 100 is traveling up a grade and 12% when the vehicle 100 is traveling down a grade.

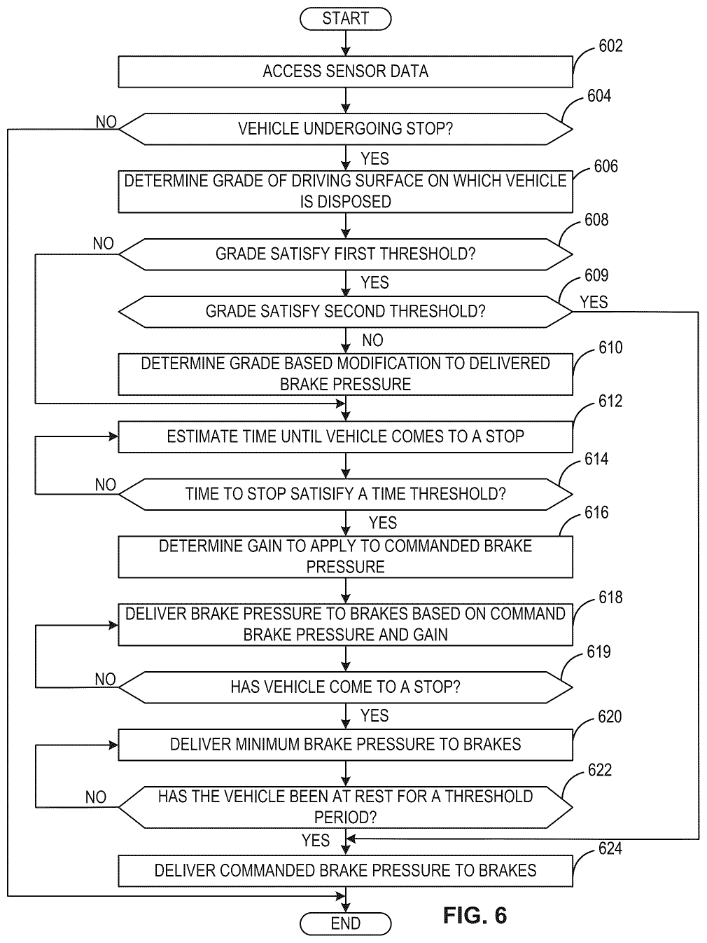

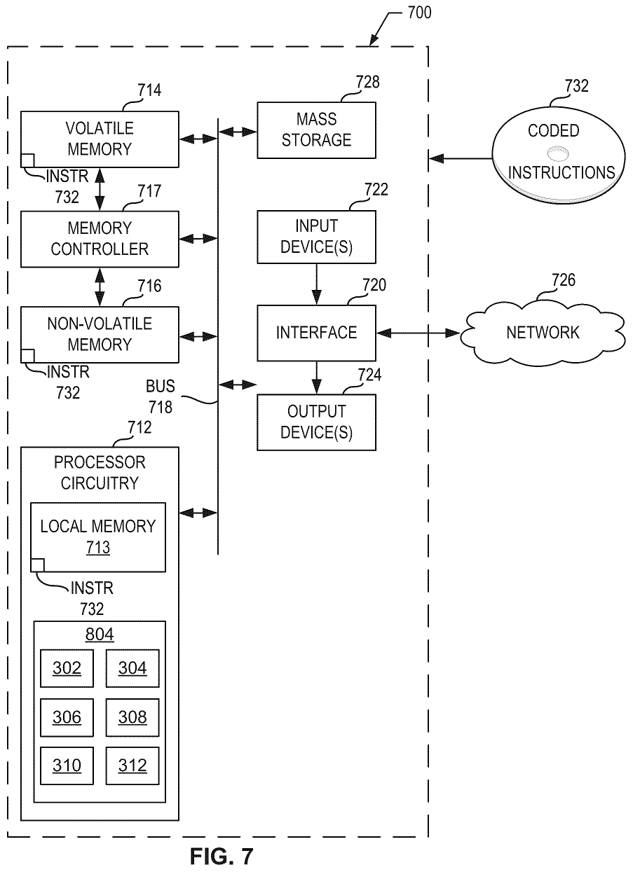

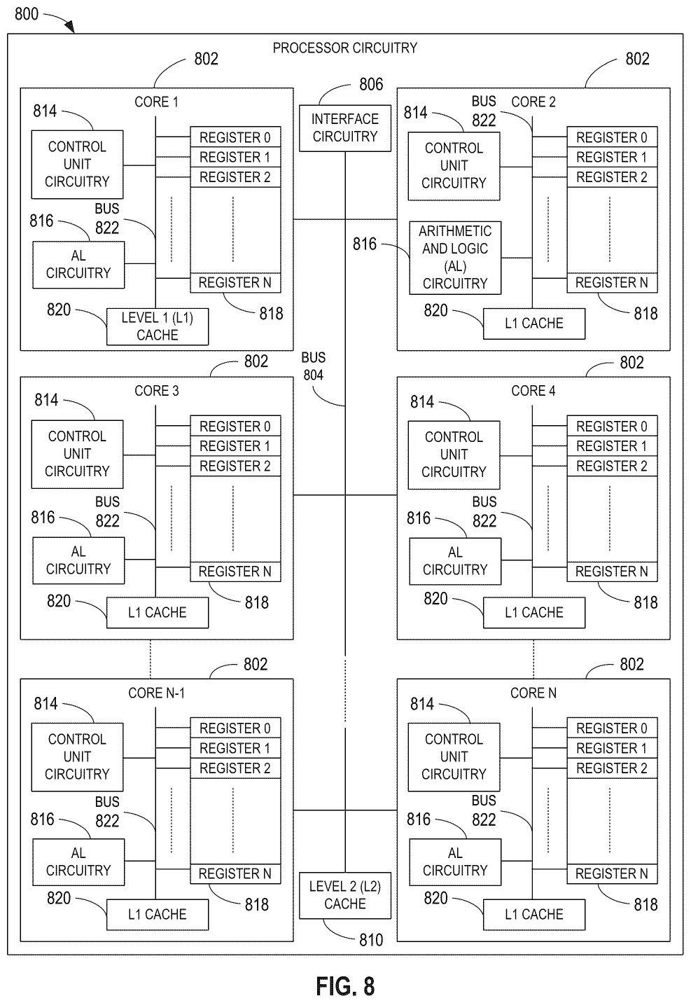

A flowchart representative of example machine readable instructions, which may be executed to configure processor circuitry to implement the brake controller 104 of FIG. 3, is shown in FIG. 6. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 6, many other methods of implementing the example brake controller 104 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry to reduce EOS jerk. The machine readable instructions and/or the operations 600 of FIG. 6 begin at block 602, at which the sensor interface circuitry 302 accesses the sensor data. For example, the sensor interface circuitry 302 can access sensor data from the sensors 208A, 208B, 208C, 208D, 110 of the example vehicle 100 and/or brake system 102. In some examples, the sensor interface circuitry 304 can transform the received sensor data from a machine-readable format (e.g., a voltage, a current, etc.) to a human-readable format (e.g., a string, a floating-point number, an integer, etc.).

At block 604, the stop determiner circuitry 304 determines if the vehicle 100 is undergoing a stop. For example, the stop determiner circuitry 304 can determine if the vehicle 100 is undergoing a stop based on a detection of the engagement of the brake system 102. In some examples, the stop determiner circuitry 304 can differentiate between vehicle slowing (e.g., to maintain distance in traffic, during yielding, etc.) and vehicle stopping (e.g., to avoid obstacles, to stop at a traffic control feature, etc.) based on a level of engagement of the brake system 102. For example, the stop determiner circuitry 304 can compare the command brake pressure to a threshold command brake pressure. In other examples, the stop determiner circuitry 304 can determine if the vehicle 100 is coming to stop by any other suitable means (e.g., via vehicle cameras, a user input, etc.).

At block 606, the grade determiner circuitry 306 determines the grade of the driving surface on which the vehicle 100 is disposed. For example, the grade determiner circuitry 306 determines the magnitude and/or the direction of the grade the vehicle is on via sensor data from the vehicle sensors 110 (e.g., an accelerometer, an optical sensor, etc.). Additionally or alternatively, the grade determiner circuitry 306 can determine the magnitude and/or the direction of the grade based on a user input from the user interface 108.

At block 608, the grade determiner circuitry 306 determines if the magnitude of the grade satisfies a first threshold. For example, the grade determiner circuitry 306 can compare the magnitude of the determined grade to a threshold grade (e.g., 0%, grade, 2% grade, 3% grade, etc.). In some examples, the first threshold corresponds to a grade (e.g., the grade 502 of FIG. 5A, the grade 510 of FIG. 5C, etc.) in which the perceivable effects of EOS jerk are partially mitigated by the gravitational effects. In some such examples, the threshold grade can be set by a user of the vehicle 100 and/or a manufacturer of the vehicle 100. In other examples, the grade determiner circuitry 306 can determine the threshold grade based on a load of the vehicle 100, the environmental conditions (e.g., the weather conditions, the external temperature, etc.), the make/model of the vehicle 100, and/or any other suitable metric. In some examples, the first threshold grade can vary based on if the vehicle 100 is traveling uphill or downhill. If the grade determiner circuitry 306 determines the magnitude of the determined grade satisfies the first threshold, the operations 600 advance to block 609. If the grade determiner circuitry 306 determines the magnitude of the grade does not satisfy the first threshold, the operations advance to block 612.

At block 609, the grade determiner circuitry 306 determines if the grade satisfies a second threshold. For example, the grade determiner circuitry 306 can compare the determined grade to a second threshold grade (e.g., 8%, grade, 10% grade, 12% grade, etc.). In some examples, the second threshold corresponds to a grade (e.g., the grade 506 of FIG. 5B, the grade 514 of FIG. 5D, etc.) in which the perceivable effects of EOS jerk are substantially mitigated by the gravitational effects and/or potential roll-back of vehicle 100 on the grade makes brake pressure reduction undesirable. In such examples, the second threshold grade can be set by a user of the vehicle 100 and/or a manufacturer of the vehicle 100. In other examples, the grade determiner circuitry 306 can determine the threshold grade based on a load of the vehicle 100, the environmental conditions (e.g., the weather conditions, the external temperature, etc.), the make/model of the vehicle 100, and/or any other suitable metric. In some examples, the second threshold grade can vary based on if the vehicle 100 is traveling uphill or downhill. If the grade determiner circuitry 306 determines the magnitude of the determined grade satisfies the second threshold, the operations 600 advance to block 624. If the grade determiner circuitry 306 determines the magnitude of the grade does not satisfy the second threshold, the operations advance to block 610.

At block 610, the gain determiner circuitry 308 determines grade based modification to delivered brake pressure. For example, if the grade is between a first threshold (e.g., a 3% grade, etc.) and a second threshold (e.g., a 10% grade, etc.), the gain determiner circuitry 308 can determine a second gain to apply to the command brake pressure. In some such examples, the delivered brake pressure can monotically increase (e.g., linearly, via a curve, etc.) from a minimum delivered brake pressure, when the magnitude of the grade is equal to the first threshold, to the command brake pressure, when the magnitude of the grade is equal to the second threshold. In other examples, the delivered brake pressure can scale to a value less than equal to command brake pressure (e.g., 99% of the command brake pressure, 95% of the command brake pressure. 75% of the command brake pressure, etc.). In other examples, the gain determiner circuitry 308 can determine any other suitable modification to the gain based on the determined grade.

At block 612, the stop time estimator circuitry 310 estimates time until vehicle 100 comes to a stop. For example, the stop time estimator circuitry 310 can estimate the time until the vehicle comes to a stop based on the current velocity of the vehicle 100 (e.g., determined via the wheel sensors 208A, 208B, 208C, 208D, etc.), a deceleration rate of the vehicle 100, and properties of the wheel sensors 208A, 208B, 208C, 208D. In some examples, the stop time estimator circuitry 310 can use kinematic principles to determine the time until the vehicle 100 comes to a stop (e.g., the ratio of current velocity to the acceleration, etc.). In some examples, the stop time estimator circuitry 310 can estimate the time until stop based on historic driver data (e.g., via a look-up table, via machine-learning algorithm, etc.). In some examples, the stop time estimator circuitry 310 can estimate the time until stop based on a resolution of the sensors 110, 208A, 208B, 208C, 208D.

At block 614, stop time estimator circuitry 310 determines if the time until stop satisfies a threshold. For example, the stop time estimator circuitry 310 can compare the estimated stop time to a predetermined stop threshold (e.g., 250 ms, etc.). In some examples, the stop time estimator circuitry 310 can determine the stop threshold based on any other suitable metric (e.g., a user setting, an environmental condition, a vehicle loading, etc.) to determine the stop threshold. If the stop time estimator circuitry 310 determines the estimated time until stop does not satisfy the threshold, the operations 600 return to block 612. If the stop time estimator circuitry 310 determines the estimated time until stop satisfies the threshold, the operations 600 advance to block 616.

At block 616, the gain determiner circuitry 308 determines the amount of gain to apply to the commanded brake pressure to generate the brake torque to be applied as the vehicle 100 is coming to a stop. In some examples, the gain determiner circuitry 308 can determine the gain to apply to the command brake pressure based on a manufacturer setting and/or a user setting. In some such examples, the manufacturer setting and/or user setting based on a make or a model of the vehicle 100. Additionally or alternatively, the gain determiner circuitry 308 can determine the gain to apply to the command brake pressure based on sensor data received from the wheel sensors 208A, 208B, 208C, 208D and/or the vehicle sensors 110 (e.g., a load on the vehicle, a brake fade of the brakes 202A, 202B, 202C, 202D, an environmental condition, etc.).

At block 618, the brake system interface circuitry 312 delivers brake pressure to the brakes based on the command brake pressure and the determined gain. For example, the brake system interface circuitry 312 can interface with the brake motors 207A, 207B, 207C, 207D and/or the boosters 210A, 210B, 210C, 210D to deliver the delivered brake pressure to the wheels 106A, 106B, 106C, 106D. In some examples, the brake system interface circuitry 312 can transition between different applied brake pressures gradually (e.g., linearly, as a ramp function, as a series of step functions, etc.). In other examples, the brake system interface circuitry 312 can apply the delivered gain by any other suitable means.

At block 619, the stop determiner circuitry 304 determines if the vehicle 100 has come to a stop. For example, the stop determiner circuitry 304 can determine if the vehicle 100 has come to stop based on a reading from one or more of the vehicle sensors 110 and/or the wheel sensors 208A, 208B, 208C, 208D. If the stop determiner circuitry 304 has determined the vehicle 100 has come to a stop, the operations 600 advance to block 620. If the stop determiner circuitry 304 has determined the vehicle 100 has not come to a stop, the operations 600 return to block 618. At block 620, the brake system interface circuitry 312 delivers minimum brake pressure to the brakes. For example, the brake system interface circuitry 312 can interface with the brake motors 207A, 207B, 207C, 207D and/or the boosters 210A, 210B, 210C, 210D to deliver the minimum brake pressure to the wheels 106A, 106B, 106C, 106D.

At block 622, the stop determiner circuitry 304 determines if the vehicle 100 has been at rest for a threshold period of time. For example, the stop determiner circuitry 304 can compare the time the vehicle 100 has been at a stop to a stop time threshold (e.g., 500 ms, 1 s, etc.). In some examples, the stop determiner circuitry 304 can determine the stop time threshold can be based on a manufacturer setting, a user setting, environmental conditions (e.g., the grade, weather, temperature, the material of the driving surface, wind speed, wind direction, etc.). In some examples, the stop determiner circuitry 304 determines the stop time threshold to ensure the sprung mass of the vehicle 100 has stopped moving relative to the wheels 106A, 106B, 106C, 106D. If the stop determiner circuitry 304, the stop determiner circuitry 304 determines the vehicle 100 has been at rest for a threshold period of time, the operations 600 advance to block 624. If the stop determiner circuitry 304, the stop determiner circuitry 304 determines the vehicle 100 has not been at rest for a threshold period of time, the operations 600 return to block 620.

At block 624, the brake system interface circuitry 312 delivers commanded brake pressure to the brakes. For example, the brake system interface circuitry 312 can deliver the command brake pressure to the brakes. For example, the brake system interface circuitry 312 can interface with the brake motors 207A, 207B, 207C, 207D and/or the boosters 210A, 210B, 210C, 210D to deliver the delivered brake pressure to the wheels 106A, 106B, 106C, 106D. In some examples, the brake system interface circuitry 312 can transition between different applied brake pressures gradually (e.g., linearly, as a ramp function, as a series of step functions, etc.). In other examples, the brake system interface circuitry 312 can apply the command pressure.

FIG. 7 is a block diagram of an example processor platform 700 structured to execute and/or instantiate the machine readable instructions and/or the operations of FIG. 6 to implement the brake controller 104 of FIGS. 1-3. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the sensor interface circuitry 302, the stop determiner circuitry 304, the grade determiner circuitry 306, the gain determiner circuitry 308, the stop time estimator circuitry 310, and the brake system interface circuitry 312.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

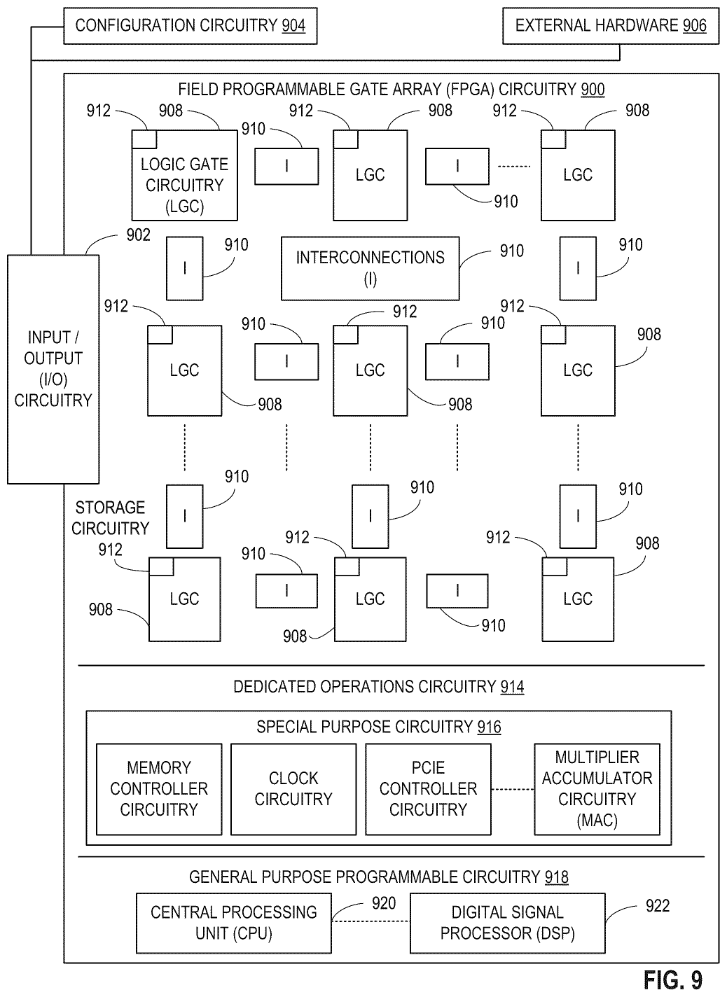

The machine readable instructions 732, which may be implemented by the machine readable instructions of FIGS. 8 and 9, may be stored in the mass storage device 728, in the volatile memory 714, in the non-volatile memory 716, and/or on a removable non-transitory computer readable storage medium such as a CD or DVD.

FIG. 5 is a block diagram of an example implementation of the processor circuitry 712 of FIG. 7. In this example, the processor circuitry 712 of FIG. 7 is implemented by a microprocessor 800. For example, the microprocessor 800 may be a general purpose microprocessor (e.g., general purpose microprocessor circuitry). The microprocessor 800 executes some or all of the machine readable instructions of the flowchart of FIG. 6 to effectively instantiate the circuitry of FIG. 3 as logic circuits to perform the operations corresponding to those machine readable instructions. In some such examples, the circuitry of FIG. 2 [er diagram] is instantiated by the hardware circuits of the microprocessor 800 in combination with the instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIG. 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 5. Alternatively, the registers 818 may be organized in any other arrangement, format, or structure including distributed throughout the core 802 to shorten access time. The second bus 822 may be implemented by at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 6 is a block diagram of another example implementation of the processor circuitry 712 of FIG. 7. In this example, the processor circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 5 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 5 described above (which is a general purpose device that may be programmed to execute some or all of the machine readable instructions represented by the flowchart of FIG. 6 but whose interconnections and logic circuitry are fixed once fabricated), the FPGA circuitry 900 of the example of FIG. 6 includes interconnections and logic circuitry that may be configured and/or interconnected in different ways after fabrication to instantiate, for example, some or all of the machine readable instructions represented by the flowchart of FIG. 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowchart of FIG. 6. As such, the FPGA circuitry 900 may be structured to effectively instantiate some or all of the machine readable instructions of the flowchart of FIG. 6 as dedicated logic circuits to perform the operations corresponding to those software instructions in a dedicated manner analogous to an ASIC. Therefore, the FPGA circuitry 900 may perform the operations corresponding to the some or all of the machine readable instructions of FIG. 6 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may be implemented by external hardware circuitry. For example, the external hardware 906 may be implemented by the microprocessor 800 of FIG. 8. The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations that may correspond to at least some of the machine readable instructions of FIG. 6 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates.

The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 5 and the example FPGA circuitry 900 of FIG. 9. In some such hybrid examples, a first portion of the machine readable instructions represented by the flowchart of FIG. 6 may be executed by one or more of the cores 802 of FIG. 8, a second portion of the machine readable instructions represented by the flowchart of FIG. 6 may be executed by the FPGA circuitry 900 of FIG. 9, and/or a third portion of the machine readable instructions represented by the flowchart of FIG. 6 may be executed by an ASIC. It should be understood that some or all of the circuitry of FIG. 3 may, thus, be instantiated at the same or different times. Some or all of the circuitry may be instantiated, for example, in one or more threads executing concurrently and/or in series. Moreover, in some examples, some or all of the circuitry of FIG. 3 may be implemented within one or more virtual machines and/or containers executing on the microprocessor.

In some examples, the processor circuitry 912 of FIG. 9 may be in one or more packages. For example, the microprocessor 800 of FIG. 8 and/or the FPGA circuitry 900 of FIG. 9 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

Example methods, apparatus, systems, and articles of manufacture to reduce end of stop jerk are disclosed herein. Further examples and combinations thereof include the following:

Example 1 includes a vehicle including a user interface, a brake system, and a controller to execute instructions to detect a command to engage the brake system at a command brake pressure, estimate a time until the vehicle comes to a stop, and in response to determining that the time satisfies a time threshold, engage the brake system at a delivered brake pressure less than the command brake pressure.

Example 2 includes the vehicle of example 1, wherein the time threshold is between 100 milliseconds and 1500 milliseconds.

Example 3 includes the vehicle of example 1, wherein the controller executes the instructions to determine the delivered brake pressure by applying a first gain to the command brake pressure, the first gain applied via a ramp function.

Example 4 includes the vehicle of example 1, wherein the controller further executes the instructions to, in response to determining a wheel of the vehicle is at rest for a period, engage the brake system at the command brake pressure.

Example 5 includes the vehicle of example 1, wherein the delivered brake pressure is a first delivered brake pressure, and the controller further executes the instructions to determine a grade on which the vehicle is disposed, and in response to determining the grade of the vehicle satisfies a first grade threshold, modify the first delivered brake pressure to a second delivered brake pressure, a difference between the first delivered brake pressure and the second delivered brake pressure based on the grade.

Example 6 includes the vehicle of example 5, wherein the second delivered brake pressure is equal to the first delivered brake pressure when the grade is equal to the first grade threshold, and the second delivered brake pressure is less than or equal to the command brake pressure when the grade satisfies a second grade threshold, the second grade threshold greater than the first grade threshold.

Example 7 includes the vehicle of example 1, further including a velocity sensor and wherein the estimation of the time is based on a velocity provided by the velocity sensor, a deceleration rate of the vehicle, a resolution of the velocity sensor, and a braking dynamic of the vehicle.

Example 8 includes a method including detecting a command to engage a brake of a vehicle at a command brake pressure, estimating a time until the vehicle comes to a stop, and in response to determining that the time satisfies a time threshold, engaging the brake at a delivered brake pressure less than the command brake pressure.

Example 9 includes the method of example 8, further including determining the delivered brake pressure by applying a first gain to the command brake pressure, the first gain applied via a ramp function.

Example 10 includes the method of example 8, further including, in response to a wheel of the vehicle being at rest for a period, engaging the brake at the command brake pressure.

Example 11 includes the method of example 8, wherein the delivered brake pressure is a first delivered brake pressure, and further including determining a grade on which the vehicle is disposed, and in response to determining the grade of the vehicle satisfies a first grade threshold, modifying the first delivered brake pressure to a second delivered brake pressure, a difference between the first delivered brake pressure and the second delivered brake pressure based on the grade.

Example 12 includes the method of example 11, wherein the second delivered brake pressure is equal to the first delivered brake pressure when the grade is equal to the first grade threshold, and the second delivered brake pressure is less than or equal to the command brake pressure when the grade satisfies a second grade threshold, the second grade threshold greater than the first grade threshold.

Example 13 includes the method of example 8, wherein the estimation of the time is based on a velocity provided by a velocity sensor, a deceleration rate of the vehicle, a resolution of the velocity sensor, and a braking dynamic of the vehicle.

Example 14 includes a non-transitory computer readable medium comprising instructions, which when executed cause a processor to at least detect a command to engage a brake of a vehicle at a command brake pressure, estimate a time until the vehicle comes to a stop, and in response to determining that the time satisfies a time threshold, engage the brake at a delivered brake pressure less than the command brake pressure.

Example 15 includes the non-transitory computer readable medium of example 14, wherein the instructions when executed cause the processor to determine the delivered brake pressure by applying a first gain to the command brake pressure, the first gain applied via a ramp function.

Example 16 includes the non-transitory computer readable medium of example 14, wherein the time threshold is between 100 milliseconds and 1500 milliseconds.

Example 17 includes the non-transitory computer readable medium of example 14, wherein the instructions when executed cause the processor to in response to a wheel of the vehicle being at rest for a period, engage the brake at the command brake pressure.

Example 18 includes the non-transitory computer readable medium of example 14, wherein the delivered brake pressure is a first delivered brake pressure and the instructions when executed cause the processor to determine a grade on which the vehicle is disposed, and in response to determining the grade of the vehicle satisfies a first grade threshold, modify the first delivered brake pressure to a second delivered brake pressure, a difference between the first delivered brake pressure and the second delivered brake pressure based on the grade.

Example 19 includes the non-transitory computer readable medium of example 18, wherein the second delivered brake pressure is equal to the first delivered brake pressure when the grade is equal to the first grade threshold, and the second delivered brake pressure is less than or equal to the command brake pressure when the grade satisfies a second grade threshold, the second grade threshold greater than the first grade threshold.

Example 20 includes the non-transitory computer readable medium of example 14, wherein the estimation of the time is based on a velocity provided by a velocity sensor, a deceleration rate of the vehicle, a resolution of the velocity sensor, and a braking dynamic of the vehicle.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A vehicle including:
a user interface;
a brake system; and
a controller to execute instructions to:
detect a command to engage the brake system at a command brake pressure;
estimate a time until the vehicle comes to a stop; and
in response to determining that the time satisfies a time threshold, engage the brake system at a delivered brake pressure less than the command brake pressure.

2. The vehicle of claim 1, wherein the time threshold is between 100 milliseconds and 1500 milliseconds.

3. The vehicle of claim 1, wherein the controller executes the instructions to determine the delivered brake pressure by applying a first gain to the command brake pressure, the first gain applied via a ramp function.

4. The vehicle of claim 1, wherein the controller further executes the instructions to, in response to determining a wheel of the vehicle is at rest for a period, engage the brake system at the command brake pressure.

5. The vehicle of claim 1, wherein the delivered brake pressure is a first delivered brake pressure, and the controller further executes the instructions to:
determine a grade on which the vehicle is disposed; and
in response to determining the grade of the vehicle satisfies a first grade threshold, modify the first delivered brake pressure to a second delivered brake pressure, a difference between the first delivered brake pressure and the second delivered brake pressure based on the grade.

6. The vehicle of claim 5, wherein:
the second delivered brake pressure is equal to the first delivered brake pressure when the grade is equal to the first grade threshold; and
the second delivered brake pressure is less than or equal to the command brake pressure when the grade satisfies a second grade threshold, the second grade threshold greater than the first grade threshold.

7. The vehicle of claim 1, further including a velocity sensor and wherein the estimation of the time is based on a velocity provided by the velocity sensor, a deceleration rate of the vehicle, a resolution of the velocity sensor, and a braking dynamic of the vehicle.

8. A method including:
detecting a command to engage a brake of a vehicle at a command brake pressure;
estimating a time until the vehicle comes to a stop; and
in response to determining that the time satisfies a time threshold, engaging the brake at a delivered brake pressure less than the command brake pressure.

9. The method of claim 8, further including determining the delivered brake pressure by applying a first gain to the command brake pressure, the first gain applied via a ramp function.

10. The method of claim 8, further including, in response to a wheel of the vehicle being at rest for a period, engaging the brake at the command brake pressure.

11. The method of claim 8, wherein the delivered brake pressure is a first delivered brake pressure, and further including:
determining a grade on which the vehicle is disposed; and
in response to determining the grade of the vehicle satisfies a first grade threshold, modifying the first delivered brake pressure to a second delivered brake pressure, a difference between the first delivered brake pressure and the second delivered brake pressure based on the grade.

12. The method of claim 11, wherein:
the second delivered brake pressure is equal to the first delivered brake pressure when the grade is equal to the first grade threshold; and
the second delivered brake pressure is less than or equal to the command brake pressure when the grade satisfies a second grade threshold, the second grade threshold greater than the first grade threshold.

13. The method of claim 8, wherein the estimation of the time is based on a velocity provided by a velocity sensor, a deceleration rate of the vehicle, a resolution of the velocity sensor, and a braking dynamic of the vehicle.

14. A non-transitory computer readable medium comprising instructions, which when executed cause a processor to at least:
detect a command to engage a brake of a vehicle at a command brake pressure;
estimate a time until the vehicle comes to a stop; and
in response to determining that the time satisfies a time threshold, engage the brake at a delivered brake pressure less than the command brake pressure.

15. The non-transitory computer readable medium of claim 14, wherein the instructions when executed cause the processor to determine the delivered brake pressure by applying a first gain to the command brake pressure, the first gain applied via a ramp function.

16. The non-transitory computer readable medium of claim 14, wherein the time threshold is between 100 milliseconds and 1500 milliseconds.

17. The non-transitory computer readable medium of claim 14, wherein the instructions when executed cause the processor to in response to a wheel of the vehicle being at rest for a period, engage the brake at the command brake pressure.

18. The non-transitory computer readable medium of claim 14, wherein the delivered brake pressure is a first delivered brake pressure and the instructions when executed cause the processor to:
determine a grade on which the vehicle is disposed; and
in response to determining the grade of the vehicle satisfies a first grade threshold, modify the first delivered brake pressure to a second delivered brake pressure, a difference between the first delivered brake pressure and the second delivered brake pressure based on the grade.

19. The non-transitory computer readable medium of claim 18, wherein:
the second delivered brake pressure is equal to the first delivered brake pressure when the grade is equal to the first grade threshold; and
the second delivered brake pressure is less than or equal to the command brake pressure when the grade satisfies a second grade threshold, the second grade threshold greater than the first grade threshold.

20. The non-transitory computer readable medium of claim 14, wherein the estimation of the time is based on a velocity provided by a velocity sensor, a deceleration rate of the vehicle, a resolution of the velocity sensor, and a braking dynamic of the vehicle.
